(19) United States
(12) Patent Application Publication
(10) Pub. No.: US 2011/0007077 A1
(43) Pub. Date: Jan. 13, 2011

(54) ANIMATED MESSAGING

(75) Inventors: Ashwin Kamath, San Ramon, CA (US); Kumar Sanjeev, San Ramon, CA (US); Ning-Chia Yeh, Alamo, CA (US)

Correspondence Address: VERIZON;PATENT MANAGEMENT GROUP, 1320 North Court House Road, 9th Floor, ARLINGTON, VA, 22201-2909, US

(73) Assignee: Verizon Patent and Licensing Inc., Basking Ridge, NJ (US)

(21) Appl. No.: 12/499,372

(22) Filed: Jul. 8, 2009

(51) Int. Cl. G06T 13/00

(52) U.S. Cl. 345/473

(57) ABSTRACT

A method performed by one or more devices includes receiving a user selection of a picture that contains an object of a character to be animated for an animated message and receiving one or more designations of areas within the picture to correspond to one or more human facial features for the character associated with the object. The method further includes receiving a textual message; receiving one or more user selections of one or more animation codes that identify animations to be performed by the one or more human facial features designated within the picture, and receiving an encoding of the textual message and the one or more animation codes. The method further includes generating the animated message based on the picture, the one or more designations of the one or more human facial features, and the one or more animation codes, and sending the animated message to a recipient.

### BACKGROUND

Animated messaging may enhance a user's experience when receiving a message. However, a user may be limited in creating a customized animated character-based message. For example, the user may have to select from a gallery of generic animated characters and/or rely on pre-programmed animations of the characters. Thus, the user may not be able to fully customize the character and/or the animation associated with the character, with respect to the message.

### BRIEF DESCRIPTION OF THE DRAWINGS

FIGS. 1A-1D are diagrams illustrating an overview of an embodiment of the animated messaging scheme described herein;

FIG. 2 is a diagram of an exemplary user device in which the embodiments described herein may be implemented;

FIG. 3 is a diagram illustrating exemplary components of a user device;

FIG. 4 is a diagram illustrating exemplary components of a messaging server;

FIG. 5 is a diagram illustrating an exemplary environment in which methods, devices, and/or systems described herein may be implemented to provide the animated messaging scheme;

FIGS. 6A-6E are diagrams illustrating exemplary graphical user interfaces (GUIs) for creating and sending an animated message; and

FIG. 7 is a diagram illustrating an exemplary process for creating and sending an animated message.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Embodiments described herein relate to an animated messaging scheme that permits a user to create characters for animation. The user may create the animated message on a user device that includes an animation messaging client. The user may send the animated message to a recipient via an animated messaging server.

In one implementation, a user may take a picture (e.g., with a camera of the user device) or obtain a picture (e.g., from a photo gallery on the user device or from a photo gallery on the animated messaging server). The picture may be of any thing, such as, for example, a person, a living thing (e.g., a tree, a plant, an animal), or a non-living thing or object.

In one implementation, the user may select features (e.g., facial features, such as, eyes, mouth, head, or the like, bodily features, such as, torso, arms, legs, feet, hands) within the picture to be animated. In another implementation, the user may upload the picture to the animated messaging server and the animated messaging server may automatically select features (e.g., based on object recognition) within the picture to be animated. The user may create a message (e.g., a text message, an e-mail, a multimedia messaging service (MMS) message, or the like) and select animations to be performed with respect to the features selected. For example, the user may encode the message with selectable animations (e.g., emoticons, animation codes, or the like). The animated message may be generated based on the picture, the selected features, the message and the animation codes. The user may preview the animated message before sending the animated message. Once the animated message is completed, the user may send the message to another user.

In other embodiments, variations to the previously described implementation exist, and will be described later. Additionally, in other implementations, the user may create the animated message according to a different order of operations than those described.

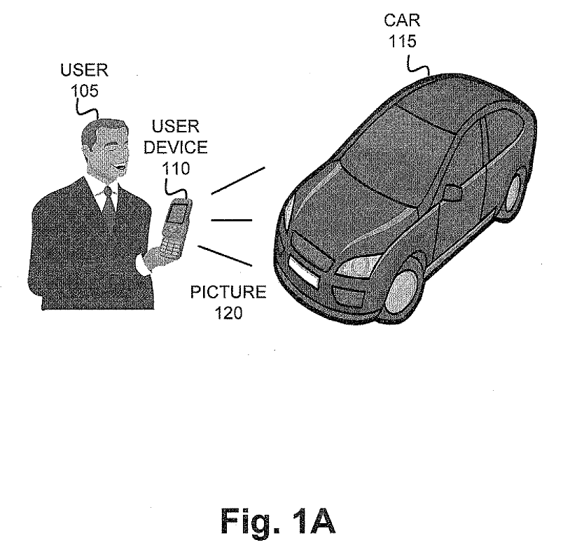

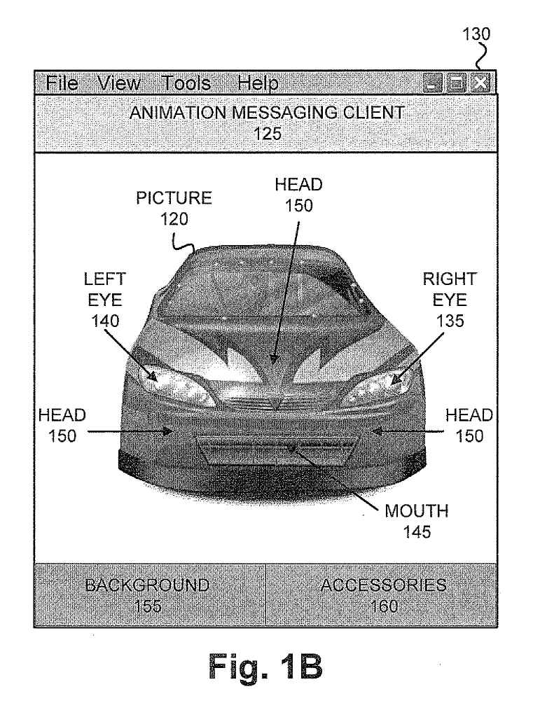

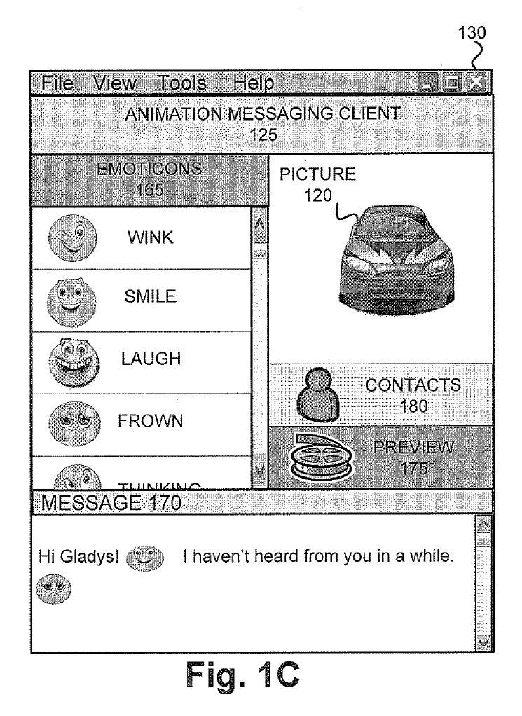

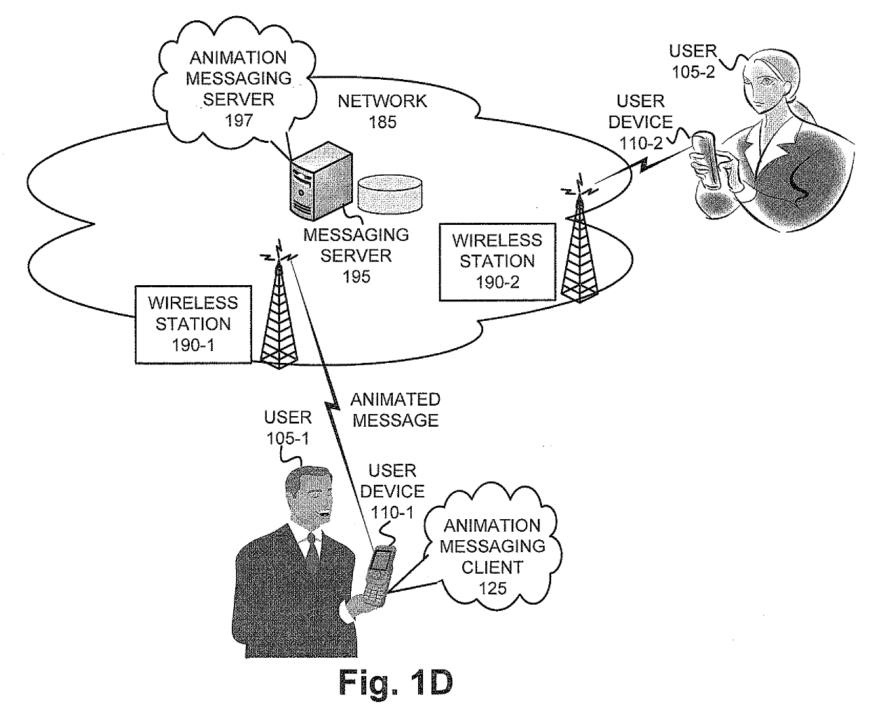

FIGS. 1A-1D are diagrams illustrating an overview of an embodiment of the animated messaging scheme described herein. As illustrated in FIG. 1A, a user 105 may operate a user device 110. In an exemplary scenario, assume that user 105 recently purchased a new car 115. User 105 would like to use his car 115 as an animated character for an animated message to his friend. User 105 may take a picture 120 of his car 115 using user device 110.

As illustrated in FIG. 1B, user device 110 may include an animation messaging client (AMC) 125 that provides a graphical user interface (GUI) 130. GUI 130 may permit user 130 to select picture 120 of car 115 to be used as an animated character. GUI 130 may permit user 105 to select areas within picture 120 to be designated as facial features, such as, for example, eyes, mouth, and head. For example, user 105 may designate exemplary feature areas with respect to picture 120 of car 115, such as, a right eye 135, a left eye 140, a mouth 145, and a head 150. In this way, user 105 may select areas of car 115 to be animated for his animated character.

User 105 may also select a background 155 and accessories 160 for car 115. For example, user 105 may select a scenic background (e.g., beach, meadow or the like) or a generic background (e.g., a color, a pattern, or the like). Additionally, user 105 may select accessories 160, such as, for example, clothing (e.g., shirt, pants, dress, blouse, hat, or the like), a costume, jewelry, and/or other types of items, to customize the appearance of car 115.

As illustrated in FIG. 1C, GUI 130 may permit user 105 to author a message portion of the animated message. For example, user 105 may enter a text message in a message field 170 of GUI 130. User 105 may select emoticons 165 that may be encoded with the text message entered by user 105. Emoticons 165 may include animations, such as, gestures, expressions, movement, and the like, which may be performed by the animated character (i.e., car 115). For example, user 105 may select from emoticons 165, such as, a wink, a smile, a laugh, a frown, a head nodding, hand waving, or other types of animations that may correspond to the facial features selected by user 105 for the animated character (e.g., car 115). In one implementation, user 105 may encode the animations into the text message by placing emoticons 165 next to a word or words of the text message. In this way, user 105 may control not only the type of animation for the animated message, but also when the animation may occur with respect to the word or words of the text message.

As illustrated in FIG. 1D, user 105-1 may connect to a network 185 using user device 110-1. In one implementation, user device 110-1 may connect to network 185 via a wireless station 190-1 (e.g., a base station). In another implementation, user device 110-1 may connect to network 185 via a wired connection. Network 185 may include a messaging server 195. Messaging server 195 may include an animation messaging server (AMS) 197. AMC 125 may connect with AMS 197 on messaging server 195.

Referring back to FIG. 1C, when connected to AMS 197, GUI 130 may permit user 105-1 to preview the animated message. For example, preview 175 may permit user 105-1 to view a video clip corresponding to the animated message before sending the animated message to his friend. GUI 130 may also provide user 105-1 access to his contacts 180 (e.g., a contacts list, a phone list, or the like). User 105-1 may select the recipient(s) of the animated message once user 105-1 is satisfied with the content of the animated message. For example, referring to FIG. 1D, user 105-1 may select user 105-2 as the recipient of the animated message. User 105-1 may send the animated message to user 105-2 via AMS 197 of messaging server 195. User 105-2 may operate user device 110-2 to receive the animated message via AMS 197 of messaging server 195. User 105-2 may connect to network 185 via a wireless station 190-2.

Although FIGS. 1A-1D illustrate an overview of an exemplary embodiment of the animated messaging scheme, in other implementations, variations to this embodiment exist and will be described below.

As a result of the foregoing, user 105 may select any character as an animated character and customize animation associated with the character, with respect to the user's 105 message. Since embodiments and implementations have been broadly described, variations to the above embodiments and implementations will be discussed further below.

In this description, user 105-1 and 105-2 may referred to generally as user 105, and user device 110-1 and 110-2 may be referred to generally as user device 110.

User device 110 may include a device having communication capability. User device 110 may include a portable, a mobile, or a handheld communication device. For example, user device 110 may include a wireless telephone (e.g., a mobile phone, a cellular phone, a smart phone), a computational device (e.g., a handheld computer, a laptop), a personal digital assistant (PDA), a web-browsing device, a personal communication systems (PCS) device, a vehicle-based device, and/or some other type portable, mobile or handheld communication device. In other implementations, user device 110 may include a stationary communication device. For example, user device 110 may include a computer (e.g., a desktop computer), a set top box in combination with a television, an Internet Protocol (IP) telephone, or some other type of stationary communication device. User device 110 may include AMC 125. AMC 125 will be described in greater detail below. User device 110 may connect to network 185 via a wired or wireless connection.

Network 185 may include one or multiple networks (wired and/or wireless) of any type. For example, network 185 may include a local area network (LAN), a wide area network (WAN), a telephone network, such as a Public Switched Telephone Network (PSTN), a Public Land Mobile Network (PLMN) or a cellular network, a satellite network, an intranet, the Internet, a data network, a private network, or a combination of networks. Network 185 may operate according to any number of protocols, standards, and/or generations (e.g., second, third, fourth).

Messaging server 195 may include a network device having communication capability. For example, messaging server 195 may include a network computer. Messaging server 195 may include AMS 197. AMS 197 will be described in greater detail below.

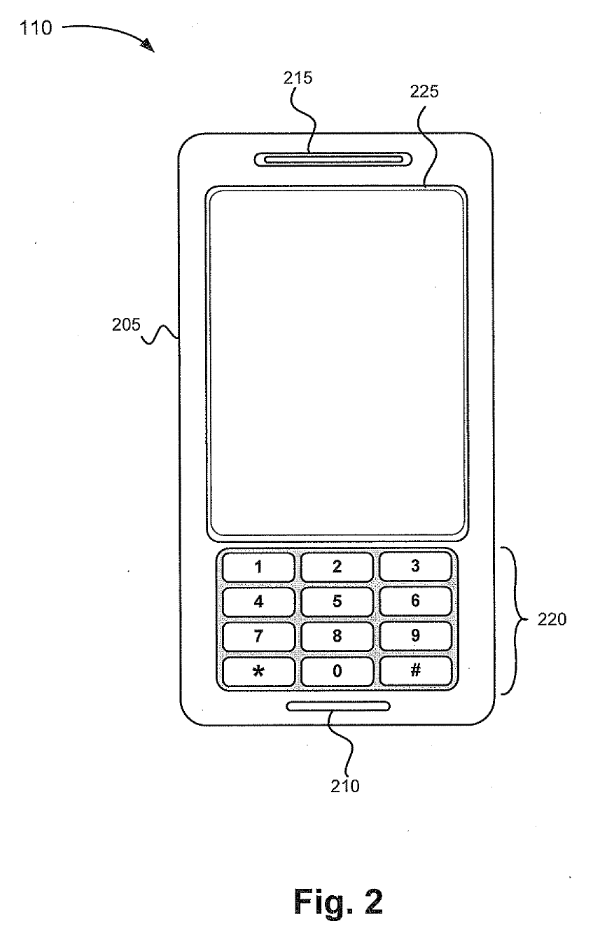

FIG. 2 is a diagram of an exemplary user device 110 in which the embodiments described herein may be implemented. As illustrated in FIG. 2, user device 110 may include a housing 205, a microphone 210, a speaker 215, a keypad 220, and a display 225. In other embodiments, user device 110 may include fewer, additional, and/or different components, or a different arrangement of components than those illustrated in FIG. 2 and described herein.

Housing 205 may include a structure to contain components of user device 110. For example, housing 205 may be formed from plastic, metal, or some other material. Housing 205 may support microphone 210, speaker 215, keypad 220, and display 225.

Microphone 210 may transduce a sound wave to a corresponding electrical signal. For example, a user may speak into microphone 210 during a telephone call or to execute a voice command. Speaker 215 may transduce an electrical signal to a corresponding sound wave. For example, a user may listen to music or listen to a calling party through speaker 215.

Keypad 220 may provide input to user device 110. Keypad 220 may include a standard telephone keypad, a QWERTY keypad, and/or some other type of keypad. Keypad 220 may also include one or more special purpose keys. In one implementation, each key of keypad 220 may be, for example, a pushbutton. A user may utilize keypad 220 for entering information, such as text or activating a special function.

Display 225 may output visual content and may operate as an input component. For example, display 225 may include a liquid crystal display (LCD), a plasma display panel (PDP), a field emission display (FED), a thin film transistor (TFT) display, or some other type of display technology. Display 225 may display, for example, text, images, and/or video information to a user. In one implementation, display 225 may include a touch-sensitive screen. Display 225 may correspond to a single-point input device (e.g., capable of sensing a single touch) or a multipoint input device (e.g., capable of sensing multiple touches that occur at the same time). Display 225 may implement, for example, a variety of sensing technologies, including but not limited to, capacitive sensing, surface acoustic wave sensing, resistive sensing, optical sensing, pressure sensing, infrared sensing, gesture sensing, etc.

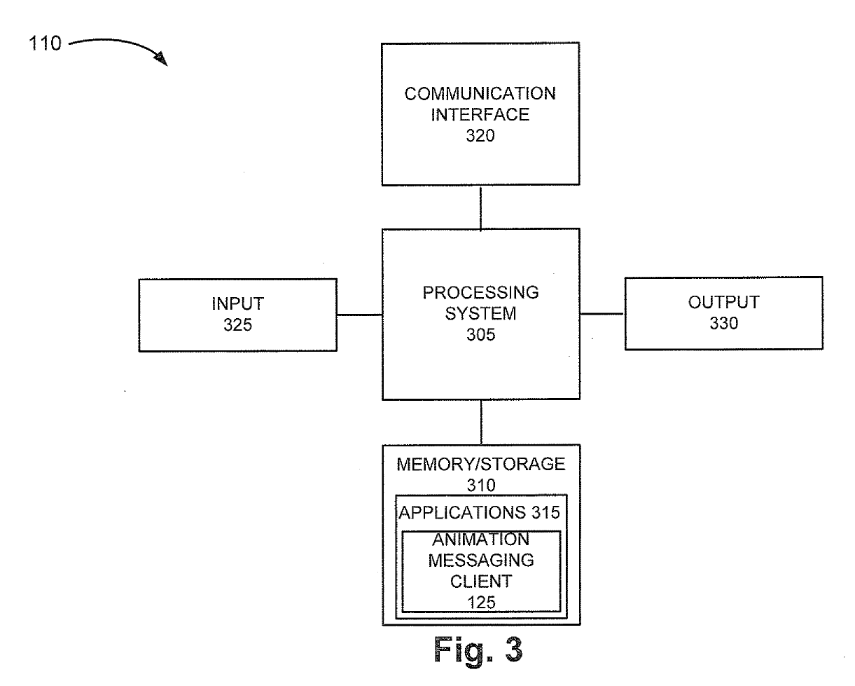

FIG. 3 is a diagram illustrating exemplary components of user device 110. As illustrated, user device 110 may include a processing system 305, a memory/storage 310 that may include applications 315, a communication interface 320, an input 325, and an output 330. In other embodiments, user device 110 may include fewer, additional, and/or different components, or a different arrangement of components than those illustrated in FIG. 3 and described herein.

Processing system 305 may include one or more processors, microprocessors, data processors, co-processors, network processors, application specific integrated circuits (ASICs), controllers, programmable logic devices, chipsets, field programmable gate arrays (FPGAs), or some other component that may interpret and/or execute instructions and/or data. Processing system 305 may control the overall operation, or a portion thereof, of user device 110, based on, for example, an operating system and/or various applications (e.g., applications 315).

Memory/storage 310 may include memory and/or secondary storage. For example, memory/storage 310 may include a random access memory (RAM), a dynamic random access memory (DRAM), a read only memory (ROM), a programmable read only memory (PROM), a flash memory, and/or some other type of memory. Memory/storage 310 may include a hard disk (e.g., a magnetic disk, an optical disk, a magneto-optic disk, a solid state disk, etc.) or some other type of computer-readable medium, along with a corresponding drive. The term “computer-readable medium” is intended to be broadly interpreted to include a memory, a secondary storage, a compact disc (CD), a digital versatile disc (DVD), or the like. The computer-readable medium may be implemented in a single device, in multiple devices, in a centralized manner, or in a distributed manner. The computer-readable medium may include a physical memory device or a logical memory device. A logical memory device may include memory space within a single physical memory device or spread across multiple physical memory devices.

Memory/storage 310 may store data, application(s), and/or instructions related to the operation of user device 110. For example, memory/storage 310 may include a variety of applications 315, such as, for example, an e-mail application, a telephone application, a camera application, a video application, a multi-media application, a music player application, a visual voicemail application, a contacts application, a data organizer application, a calendar application, an instant messaging application, a texting application, a web browsing application, a location-based application (e.g., a GPS-based application), a blogging application, and/or other types of applications (e.g., a word processing application, a spreadsheet application, etc.). Applications 315 may include AMC 125. AMC 125 may permit a user to create and send an animated message. AMC 125 will be described in greater detail below.

Communication interface 320 may permit user device 110 to communicate with other devices, networks, and/or systems. For example, communication interface 320 may include an Ethernet interface, a radio interface, a microwave interface, or some other type of wireless and/or wired interface.

As described herein, user device 110 may perform certain operations in response to processing system 305 executing software instructions contained in a computer-readable medium, such as memory/storage 310. The software instructions may be read into memory/storage 310 from another computer-readable medium or from another device via communication interface 320. The software instructions contained in memory/storage 310 may cause processing system 305 to perform processes described herein. Alternatively, hardwired circuitry may be used in place of or in combination with software instructions to implement processes described herein. Thus, implementations described herein are not limited to any specific combination of hardware circuitry and software.

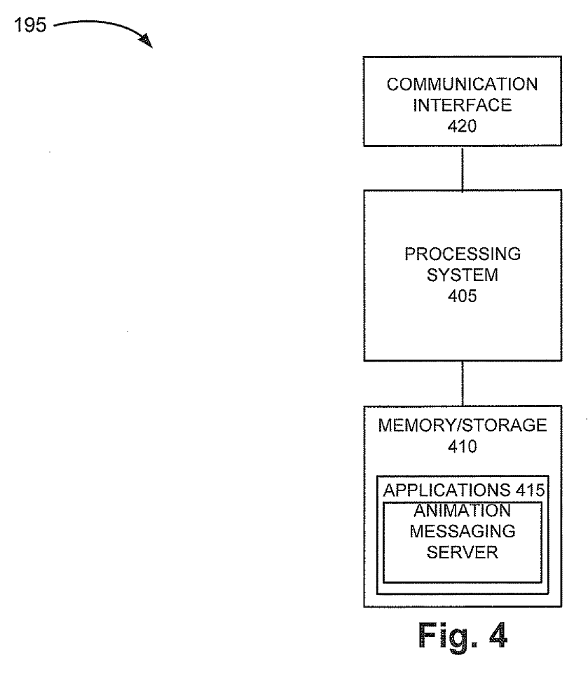

FIG. 4 is a diagram illustrating exemplary components of messaging server 195. As illustrated, messaging server 195 may include a processing system 405, a memory/storage 410 that may include applications 415, and a communication interface 420. In other embodiments, messaging server 195 may include fewer, additional, and/or different components, or a different arrangement of components than those illustrated in FIG. 4 and described herein.

Processing system 405 may include one or more processors, microprocessors, data processors, co-processors, network processors, application specific integrated circuits (ASICs), controllers, programmable logic devices, chipsets, field programmable gate arrays (FPGAs), or some other component that may interpret and/or execute instructions and/or data. Processing system 405 may control the overall operation, or a portion thereof, of messaging server 195, based on, for example, an operating system and/or various applications (e.g., applications 415).

Memory/storage 410 may include memory and/or secondary storage. For example, memory/storage 410 may include a RAM, a DRAM, a ROM, a PROM, a flash memory, and/or some other type of memory. Memory/storage 410 may include a hard disk (e.g., a magnetic disk, an optical disk, a magneto-optic disk, a solid state disk, etc.) or some other type of computer-readable medium, along with a corresponding drive.

Memory/storage 410 may store data, application(s), and/or instructions related to the operation of messaging server 195. For example, memory/storage 410 may include applications 415 that may permit a user to create and send an animated message. Applications 415 may include AMS 197. AMS 197 will be described in greater detail below. In one embodiment, applications 415 may include an authentication authorization, and accounting (AAA) application. In other embodiments, messaging server 195 may not include an AAA application.

Communication interface 420 may permit messaging server 195 to communicate with other devices, networks, and/or systems. For example, communication interface 420 may include an Ethernet interface, a radio interface, or some other type of wireless and/or wired interface.

As described herein, messaging server 195 may perform certain operations in response to processing system 405 executing software instructions contained in a computer-readable medium, such as memory/storage 410. The software instructions may be read into memory/storage 410 from another computer-readable medium or from another device via communication interface 420. The software instructions contained in memory/storage 410 may cause processing system 405 to perform processes described herein. Alternatively, hardwired circuitry may be used in place of or in combination with software instructions to implement processes described herein. Thus, implementations described herein are not limited to any specific combination of hardware circuitry and software.

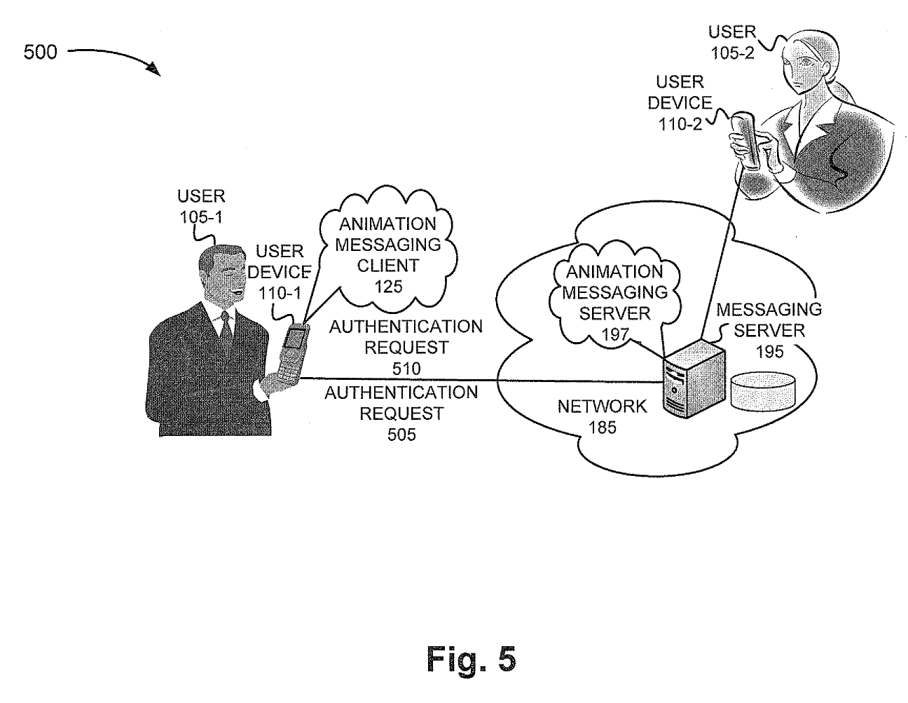

FIG. 5 is a diagram illustrating an exemplary environment 500 in which methods, devices, and/or systems described herein may be implemented to provide the animated messaging scheme. It will be appreciated that the number of devices, networks, and/or configuration in environment 500 is exemplary and provided for simplicity. In practice, environment 500 may include more, fewer, different, and/or differently arranged devices and/or network than those illustrated in FIG. 5. Also, some functions described as being performed by a particular device or network may be performed by a different device or network, or a combination thereof, in other implementations.

As previously described, user device 110 may include AMC 125. AMC 125 may operate synchronously with AMS 197 to provide user 105 with the ability to create an animated message and send the animated message to the recipient (e.g. another user 105), as illustrated in FIG. 5.

In an exemplary embodiment, user 105 may need to log in with AMS 197 of messaging server 195 before utilizing an animated messaging service. In one embodiment, messaging server 195 may provide AAA services. In other embodiments, AMS 197 may negotiate with an AAA server (not illustrated) to provide AAA services.

Referring to FIG. 5, in an exemplary implementation, user 105-1 may send an authentication request 505 to AMS 197 of messaging server 195. Authentication request 505 may include a mobile directory number (MDN) associated with user 105-1, a key (e.g., a hash token), a network address (e.g., an IP address from user device 110-1, and a device type (e.g., a user device name). The key may be generated based on, for example, a date/time combination added to a hashing of the date/time combination, a private key, and the MDN. AMS 197 and/or the AAA server may authenticate user 105-1, and if the authentication process is successful, may respond with an authentication response 510 that includes a session token. The session token may have a time-to-live, in which the duration of the time-to-live may be configured by a network administrator. For example, the duration of the time-to-live may correspond to a single animated messaging session, multiple days, or one or more months. In one implementation, AMC 125 may erase the session token from memory/storage 310 if user device 110-1 is hard reset or powered off.

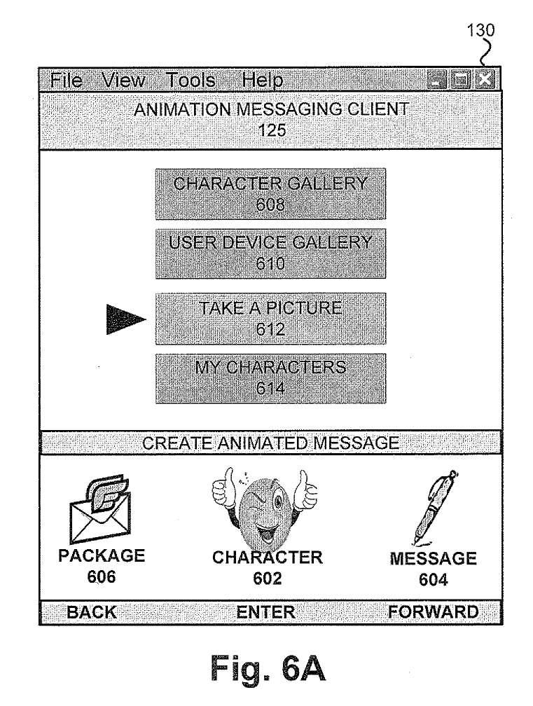

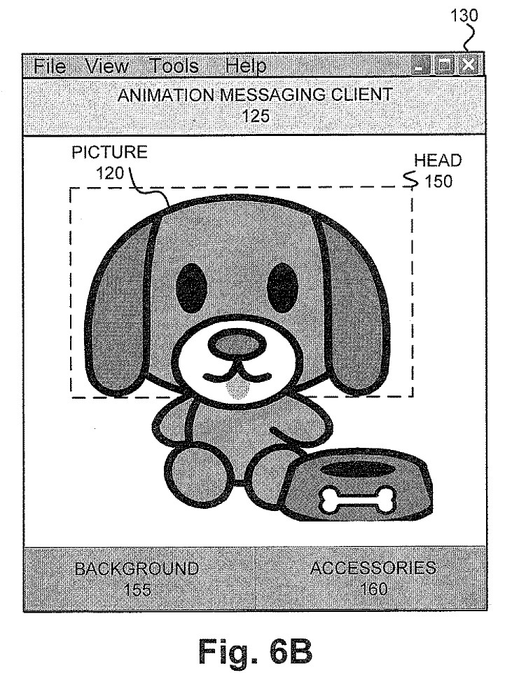

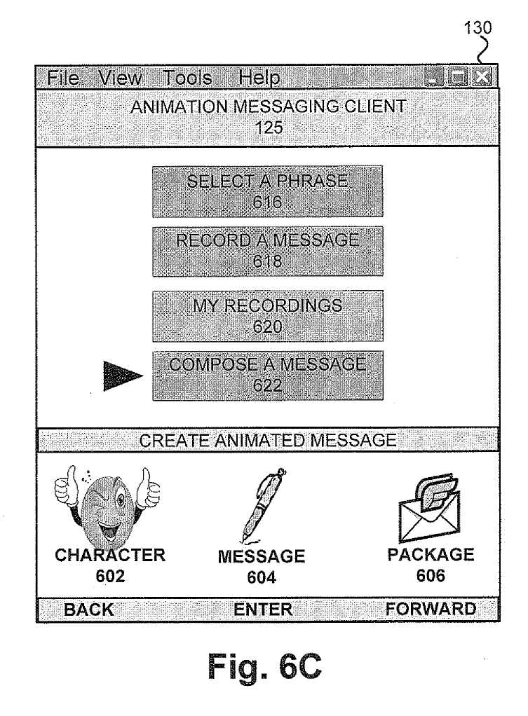

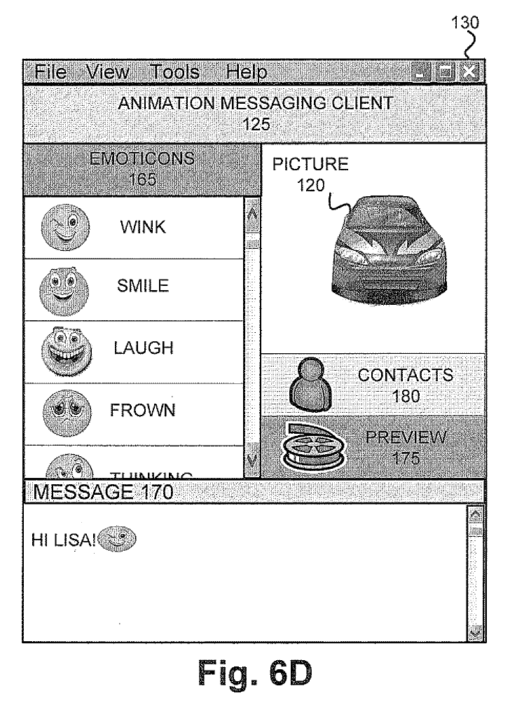

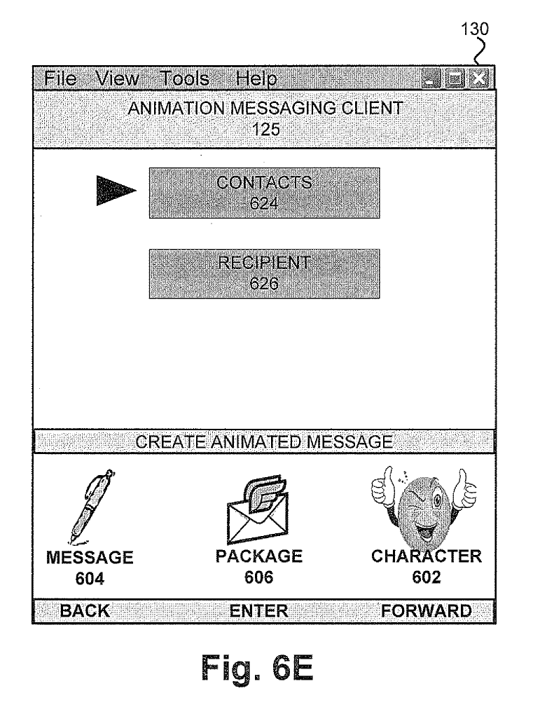

FIGS. 6A-6E are diagrams illustrating exemplary GUIs for creating and sending an animated message. It will be appreciated that content accessed from the exemplary GUIs, as described herein, may be stored on user device 110 and/or messaging server 195. Additionally, it will be appreciated that operations associated with the creation and sending of an animated message, as described herein, may be performed by user device 110 (e.g., AMC 125) and/or messaging server 195 (e.g., AMS 197).

FIG. 6A is a diagram illustrating an exemplary GUI 130. As illustrated, GUI 130 may permit user 105 to create an animated message. In an exemplary implementation, GUI 130 may provide a main menu that allows user 105 to select a character 602, create a message 604, and package 606 an animated message.

Referring to FIG. 6A, assume that user 105 wishes to create an animated character. User 105 may select character 602 on GUI 130. GUI 130 may provide for user selections, such as, a character gallery 608, a user device gallery 610, take a picture 612, and a My Characters 614.

Character gallery 608 may include a gallery of characters that may be stored on messaging server 195. The characters may be indexed according to various categories (e.g., animals, people, plant life, objects, etc.). Character gallery 608 may include popular people (e.g., movie stars, musicians, etc.), cartoon characters, generic characters, holiday characters, holiday icons (e.g., Valentine heart, Christmas tree), and other types of characters according to one or more category lists. Character gallery 608 may include free character content or premium character content (e.g., in which user 105 may purchase).

User device gallery 610 may include a gallery of characters that are stored on user device 110. For example, user 105 may store pictures on his or her user device 110.

Take a picture 612 may permit user 105 to launch a camera (e.g., included with user 110) and capture a picture. GUI 130 may permit user 105 to preview the picture before accepting the picture as the character to be animated. GUI 130 may permit user 105 to save the picture in user device gallery 610 or upload the picture to My Characters 614. My Characters 614 may be stored on messaging server 195 and correspond to a space where user 105 may store pictures and/or animated characters that user 105 has previously utilized for an animated message.

As previously described, when a character has been selected, features associated with the character may be animated. By way of example, the features may include facial features (e.g., head, nose, eyes, mouth) and bodily features (e.g., arms, legs, torso, hands, feet). In one embodiment, user 105 may select the features to be animated. For example, FIG. 6B is a diagram illustrating an exemplary GUI 130. As illustrated, GUI 130 may permit user 105 to select features to be animated. In this example, assume that the character (e.g., picture 120) is a dog. User 105 may select head 150 of the dog. For example, GUI 130 may permit user 105 to designate an area of picture 120 as head 150. In this example, the designation is illustrated as a box. However, in other implementations, the designation may be illustrated to user 105 in another manner. In this way, user 105 may designate feature areas of the character, which may be subsequently animated.

Additionally, or alternatively, in another embodiment, messaging server 195 may select the feature areas of the character. For example, messaging server 195 or user device 110 may include an object recognition application that may be capable of discerning various features of a character, such as, for example, the head, eyes, mouth, legs, etc. In instances when picture 120 does not correspond to a thing that inherently has these features (e.g., a tree), default feature areas may be selected. Alternatively, as previously described, user 105 may designate features areas of the character. Additionally, as previously described, GUI 130 may permit user 105 to select background 155 and accessories 160. Background 155 of GUI 130 may provide user 105 access to background content and accessories 160 of GUI 130 may provide user 105 access to accessories content from which user 105 may select.

FIG. 6C is a diagram illustrating an exemplary GUI 130. As illustrated, GUI 130 may permit user 105 to create a message. Referring to FIG. 6C, assume that user 105 wishes to create a message. User 105 may select message 604 on GUI 130. GUI 130 may provide for user selections, such as, select a phrase 616, record a message 618, My Recordings 620, and compose a message 622.

Select a phrase 616 may permit user 105 to select from a list of pre-recorded audio phrases. The pre-recorded audio phrases may be categorized based on context. For example, pre-recorded phases may include generic messages (e.g., “Call me”, “See you tomorrow,” “Meet you there,” “I am running late,” etc.), specialty messages (e.g., messages related to holidays, anniversaries, birthdays, etc.), and/or other types of messages from which user 105 may select.

Record a message 618 may permit user 105 to record a message. For example, user 105 may speak into microphone 210 of user device 110. When record a message 618 is selected, GUI 130 may provide user 105 with other selections, such as, record, play, stop, and accept. GUI 130 may indicate the length of time of the recorded message. GUI 130 may permit user 105 to name and save the recorded message file. GUI 130 may permit user 105 to save the recording on user device 110 or upload the recording to My Recordings 620. My Recordings 620 may be stored on messaging server 195 and correspond to a space where user 105 may store recordings and/or other audio files that user 105 has previously utilized for an animated message.

Compose a message 622 may permit user 105 to enter a message (e.g., by typing a message or utilizing a voice-to-text application). For example, depending on user device 110, user 105 may enter a message utilizing keypad 220 or GUI 130 may provide soft keys to enter a message. Additionally, as previously described, user 105 may select gestures to be added to the message. For example, referring to FIG. 6D, in message field 170, user 105 may enter a message and utilize emoticons 165 to indicate an animation (e.g., a gesture, an expression, a movement, or the like). In other implementations, user 105 may be provided with a different way in which to encode a message with animation. For example, GUI 130 may provide animation codes. The animation codes may be textual, selectable from a menu (e.g., “y)” may represent a nod for the head of the character or “˜w” may cause a hand to wave) and/or typed by user 105. In either implementation, user 105 may encode the animations into the message by placing emoticons 165 or some form of animation code (e.g., a textual code) next to a word or words of the message. In this way, user 105 may control not only the type of animation in the animated message, but also when the animation may occur with respect to the word or words of the message.

With respect to select a phrase 616 and compose a message 622, GUI 130 may permit user 105 with selections of voices for the animated character. For example, GUI 130 may provide categories of male and female voices. User 105 may be permitted to select from celebrity voices or other types of voices (e.g., cartoon voices, etc.). GUI 130 may permit user 105 to select various languages (e.g., English, Spanish, French, etc.) in which the message is to be spoken.

As previously described, user 105 may preview the animated message by selecting preview 175, as illustrated in FIG. 6D. User 105 may decide whether the animated message (i.e., a video animated message) is acceptable. In some instances, depending on, for example, the resource capabilities of user device 110, the generation of the animated message may be performed on messaging server 195 or another device (not illustrated). In such an implementation, the user's selections pertaining to the animated message (e.g., the character, designation of features, the message, animation codes, etc.) will be made available to messaging server 195 or the other device. In other instances, applications 315 of user device 110 may include an application to generate the animated message based on user's 105 selections.

FIG. 6E is a diagram of an exemplary GUI 130. As illustrated, GUI 130 may permit user 105 to send the animated message. Referring to FIG. 6E, assume that user 105 wishes to send the animated message. User 105 may select package 606 on GUI 130. GUI 130 may provide for user selections, such as contacts 624 and recipient 626.

Contacts 624 may permit user 105 to select from a contact lists, a phone list, or the like, which may be stored on user device 110. User 105 may select the recipient(s) of the animated message from contacts 624. For example, user 105 may select a telephone number or an e-mail address of the recipient(s). Recipient 626 may permit user 105 to enter a telephone number or an e-mail address directly (e.g., without accessing a contact list). User 105 may send the animated message via messaging server 195.

Although FIGS. 6A-6E illustrate exemplary GUIs, in other implementations, the GUIs may provide a different user interface and/or different user selections. Additionally, the order in which GUIs 130 have been illustrated and described is exemplary. In other implementations, user 105 may create the animated message by utilizing GUIs 130 in a different order.

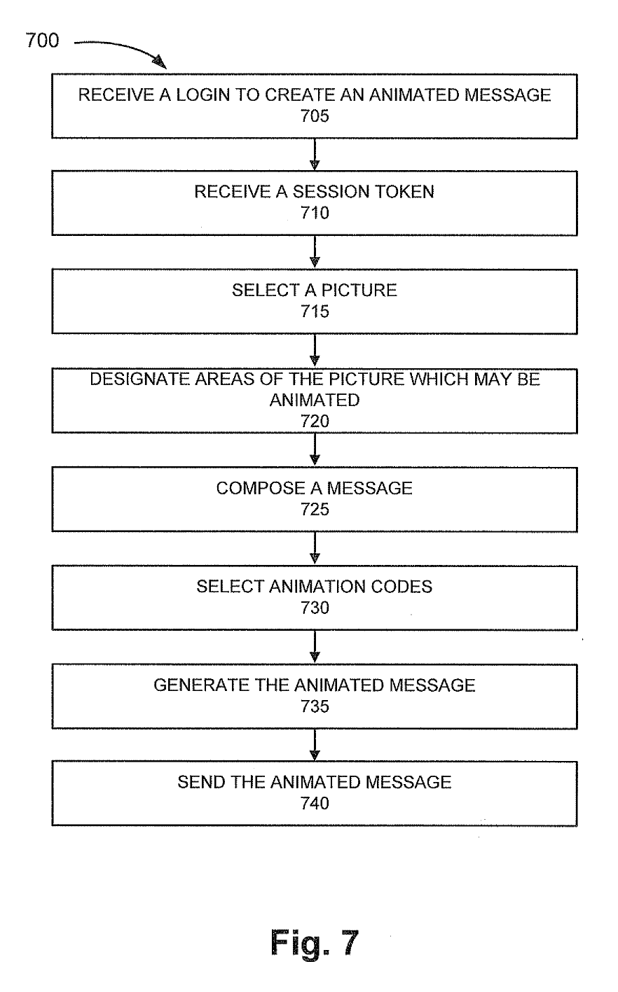

FIG. 7 is a diagram illustrating an exemplary process 700 for creating and sending an animated message. Process 700 may be performed, wholly or partially, by user device 110 or messaging server 195. In other implementations, a portion of process 700 (e.g., the generation of the animated message) may be performed by another device (e.g., a network server having an animation generating application). In such instances, user device 110 and/or messaging server 195 may provide the other device with user's 105 selection information.

Process 700 may begin with receiving a login to create an animated message (block 705). For example, as previously described and illustrated with respect to FIG. 5, user 105 may send authentication request 505 to AMS 197 via user device 110 (e.g., AMC 125). Authentication request 505 may include a mobile directory number (MDN) associated with user 105-1, a key (e.g., a hash token), a network address (e.g., an IP address from user device 110-1, and a device type (e.g., a user device name). The key may be generated based on, for example, a date/time combination added to a hashing of the date/time combination, a private key, and the MDN. AMS 197 and/or an AAA server may authenticate user 105-1.

A session token may be received (block 710). For example, assuming the authentication process is successful, AMS 197 or the AAA server may respond to user device 110 (i.e., AMC 125) with authentication response 510 that includes a session token. The session token may have a time-to-live, in which the duration of the time-to-live may be configured by a network administrator. For example, the duration of the time-to-live may correspond to a single animated message session, multiple days, or one or more months. In one implementation, AMC 125 may erase the session token from memory/storage 310 if user device 110 is hard reset or powered off.

A picture may be selected (block 715). For example, AMC 125 may receive a selection of picture 120. In one implementation, as previously described, user 105 may take picture 120 with user device 110. AMC 125 may receive a user selection of picture 120 that was taken. In other implementations, AMC 125 may receive a user selection of picture 120 from character gallery 608, user device gallery 610, or My Characters 614.

Areas of the picture, which may be animated, may be designated (block 720). For example, as previously described and illustrated with respect to FIG. 6B, AMC 125 may receive one or more selections of features for a character in picture 120. For example, the features may include facial features (e.g., head, nose, eyes, mouth) and bodily features (e.g., arms, legs, torso, hands, feet). In one embodiment, user 105 may select the features to be animated. In another embodiment, features may be automatically selected based on an object recognition application.

A message may be composed (block 725). For example, as previously described and illustrated with respect to FIG. 6C, AMC 125 may compose the message based on phrase 616, record a message 618, My Recordings 620, or compose a message 622.

Animation codes may be selected (block 730). For example, as previously described and illustrated with respect to FIG. 6D, AMC 125 may receive user's 105 selections of animation codes. The animation codes may correspond to, for example, emoticons 165 or other types text-based animation codes ((e.g., “y)” may represent a nod for the head of the character). The message composed may be encoded with the animation codes so that the selected features may be animated in correspondence with the animation codes.

The animated message may be generated (block 735). For example, as previously described, user device 110, messaging server 195, or another device, may generate the animated message based on the user's 105 selections (e.g., the character, designation of features, the message, animation codes, etc.) pertaining to the animated message.

The animated message may be sent (block 740). For example, as previously described, user 105 may send the animated message based on contacts 624 or recipient 626. For example, AMC 125 may receive a selection of a recipient via contacts 624 (e.g., a contacts list or telephone list residing on user device 110). Alternatively, AMC 125 may user 105 may enter a telephone number or e-mail address directly, without accessing a contacts list. The animated message may be sent via e-mail or as an MMS message according to the address or telephone number entered.

Although FIG. 7 illustrates an exemplary process 700, in other implementations, additional, fewer, and/or different operations than those described, may be performed. For example, process 700 may include receiving selections associated with a background and/or accessories. Additionally, although a particular operation of process 700 is described as being performed by a device, such as user device 110, in other implementations, a different device (e.g., messaging server 195) may perform the operation, or the particular operation may be performed in combination therewith.

The foregoing description of implementations provides illustration, but is not intended to be exhaustive or to limit the implementations to the precise form disclosed. Accordingly, modifications to the embodiments, implementations, etc., described herein may be possible.

The term “may” is used throughout this application and is intended to be interpreted, for example, as “having the potential to,” “configured to,” or “being able to,” and not in a mandatory sense (e.g., as “must”). The terms “a,” “an,” and “the” are intended to be interpreted to include one or more items. Where only one item is intended, the term “one” or similar language is used. Further, the phrase “based on” is intended to be interpreted as “based, at least in part, on,” unless explicitly stated otherwise. The term “and/or” is intended to be interpreted to include any and all combinations of one or more of the associated list items.

In addition, while a series of blocks has been described with regard to the process illustrated in FIG. 7, the order of the blocks may be modified in other implementations. Further, non-dependent blocks may be performed in parallel.

It will be apparent that the device(s) described herein may be implemented in many different forms of software or firmware in combination with hardware in the implementations illustrated in the figures. The actual software code (executable by hardware) or specialized control hardware used to implement these concepts does not limit the disclosure of the invention. Thus, the operation and behavior of a device(s) was described without reference to the specific software code—it being understood that software and control hardware can be designed to implement the concepts based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the present application should be construed as critical or essential to the implementations described herein unless explicitly described as such.

What is claimed is:

1. A method comprising:
receiving, by one or more devices, a user selection of a picture that contains an object of a character to be animated for an animated message;
receiving, by the one or more devices, one or more designations of areas within the picture to correspond to one or more human facial features for the character associated with the object;
receiving, by the one or more devices, a textual message;
receiving, by the one or more devices, one or more user selections of one or more animation codes that identify one or more animations to be performed by the one or more human facial features designated within the picture;
receiving, by the one or more devices, an encoding of the textual message and the one or more animation codes;
generating, by the one or more devices, the animated message based on the picture, the one or more designations of the one or more human facial features, and the one or more animation codes; and
sending, by the one or more devices, the animated message to a recipient.

2. The method of claim 1, where the encoding comprises:
inserting the one or more animation codes, in the textual message, based on one or more placements of the one or more animation codes with respect to words of the textual message, by the user.

3. The method of claim 1, where the human facial features correspond to at least one of head, mouth, eyes, or nose.

4. The method of claim 1, where the object corresponds to either a living thing or a non-living thing.

5. The method of claim 1, where the one or more designations of areas within the picture are user designations.

6. The method of claim 1, further comprising,
capturing, by one of the one or more devices, the picture; and
storing, by the one or more devices, the picture.

7. The method of claim 1, further comprising:
receiving, by the one or more devices, one or more designations of areas within the picture to correspond to one or more bodily features for the character associated with the object.

8. The method of claim 1, further comprising:
performing, by the one or more devices, object recognition of the object; and
receiving, by the one or more devices, one or more designations of areas within the picture to correspond to one or more human facial features for the character associated with the object, based on the object recognition.

9. A device comprising:
one or more memories to store instructions; and
one or more processors to execute the instructions in the one or more memories to:
receive a user selection of a picture containing a character to be animated;
receive designations of regions of the picture that are to correspond to facial features to be animated;
receive a textual message that includes animation codes, the animation codes indicating animations to be performed by the regions of the picture that correspond to the facial features;
generate an animated message based on the textual message that includes the animation codes and the picture; and
send the animated message to another user.

10. The device of claim 9, where the device includes a mobile phone.

11. The device of claim 9, where the designations of the regions of the picture are selected by the user.

12. The device of claim 9, where the animated message corresponds to a video clip and the animated message is sent to the other user as an e-mail or a multimedia messaging service message.

13. The device of claim 9, where the character in the picture is of a non-living thing.

14. The device of claim 9, where the one or more processors execute the instructions to:
take the picture; and
store the picture on the device.

15. The device of claim 9, where, when receiving the designations, the one or more processors execute the instructions to:
receive the designations of the regions of the picture based on an object recognition application.

16. The device of claim 9, where the one or more processors execute the instructions to:
receive designations of regions of the picture that are to correspond to bodily features to be animated.

17. The device of claim 9, where the designations of the regions of the picture correspond to the user selection of the designations.

18. The device of claim 17, where the designations of the regions of the picture that correspond to the facial features include eyes, mouth, and head.

19. A computer-readable medium containing instructions executable by at least one processor, the computer-readable medium storing instructions for:
receiving a request for creating an animated message having a character that is animated;
receiving a user selection of a picture to be animated;
identifying areas of the picture to be animated, where the areas correspond to facial features including eyes, mouth and head;
receiving a textual message that includes a user selection of animation codes, the animation codes indicating facial feature animations to be performed by the identified areas of the picture; and
generating the animated message based on the received textual message that includes the animation codes and the picture.

20. The computer-readable medium of claim 19, where a portable communication device includes the computer-readable medium, and the computer-readable medium includes one or more instructions for:
providing a contacts list from which the user may select another user; and
sending the generated animated message to a selected other user.
